(19) United States
(12) Patent Application Publication
(10) Pub. No.: US 2021/0356263 A1
(43) Pub. Date: Nov. 18, 2021

(54) Surface Topography Sensing

(71) Applicant: University of Nottingham, Nottingham (GB)

(72) Inventors: Richard Leach, Nottingham (GB); Nicola Senin, Nottingham (GB)

(21) Appl. No.: 17/284,347

(22) PCT Filed: Oct. 10, 2019
(86) PCT No.: PCT/GB2019/052876

§ 371 Date: Apr. 9, 2021

(30) Foreign Application Priority Data
Oct. 10, 2018 (GB) 1816526.6

(51) Int. Cl. G01B 11/30; G06N 3/08; B33Y 50/02; B22F 10/38; B22F 10/85

(52) U.S. Cl. CPC G01B 11/303; G06N 3/08; B22F 10/85; B22F 10/38; B33Y 50/02

(57) ABSTRACT

A surface topography sensing apparatus (10) comprises a light source (11) operable to generate a reference light beam (12) which is incident upon a surface (1). The scattered reference light (13) is captured by a light detector (14), thereby capturing a characteristic angular scattering distribution (ASD) for the point where the beam (12) scatters from surface (1). The ASD is generated by a processing module (16) connected to the light detector (14). Once the ASD is generated, the processing module 16 is operable to compare the generated ASD against a library (17) of sample ASDs, each sample ASD representative of a particular expected surface topography condition for the specific application being studied. Based on the comparison, the processing module may then assign a classification of the topography of surface (1).

### TECHNICAL FIELD OF THE INVENTION

The present invention relates to surface topography sensing.

### BACKGROUND TO THE INVENTION

The surface topography of a part can have a profound effect on the function of the part itself. It is estimated that surface effects cause 10% of manufactured parts to fail. For one example, in tribology, it is the surface interactions that influence such quantities as friction, wear and the lifetime of a component. For another example, in fluid dynamics, it is the surface that determines how fluids flow and it affects such properties as aerodynamic lift, therefore, influencing efficiency and fuel consumption of aircraft.

In some manufacturing techniques, surface topography can be rectified by a separate finishing process. Where this is difficult or inappropriate, including for example additive manufacturing, achieving a desired surface topography requires careful control of the manufacturing process. To confirm topography and accurately control manufacturing it is necessary to be able to measure surface topography in process, that is, when a part is being made.

There are existing instruments that can measure surface topography where the surface height features are of the order of tens to hundreds of micrometres. Typically, these instruments cannot be used realistically for in-process applications due to the need for scanning in either the lateral axes and/or the vertical axis. Even surface measuring instruments that are considered “fast” (e.g. chromatic confocal microscopy), would still take several seconds to measure topography over a millimetre square area.

Existing commercial scattering instruments that can measure surfaces in real-time, only operate on surfaces where the height features are less than, or of the order of, the source wavelength (usually visible light). As such they are primarily designed for finished optical surfaces (e.g. lenses, mirrors).

An additional issue is that commercial surface measuring sensors require expensive hardware to process the sensor output. This expense mitigates against the use of such sensors on a routine basis.

It is therefore an object of the present invention to provide a method and apparatus that at least partially alleviates or overcomes the above problems.

### SUMMARY OF THE INVENTION

According to a first aspect of the present invention there is provided a method of sensing the topography of a surface, the method comprising the steps of: illuminating the surface with a reference light source; detecting reference light scattered from the surface; detecting the intensity of the reference light scattered from the surface to generate an angular scattering distribution (ASD); comparing the generated ASD to a library of sample ASDs, each sample ASD representative of a particular surface topography condition; and assigning a classification of the topography of the surface in response to the outcome of the comparison.

According to a second aspect of the present invention there is provided an apparatus for sensing the topography of a surface, the apparatus comprising: a reference light source operable to illuminate the surface; a light detector operable to detect the reference light scattered from the surface; a processing module operable in response to the light detector to: generate an angular scattering distribution (ASD) of the scattered reference light; compare the generated ASD to a library of sample ASDs, each sample ASD representative of a particular surface topography condition; and assigning a classification of the topography of the surface in response to the outcome of the comparison.

The present invention provides for the measurement of surfaces with height features of the order of tens to hundreds of micrometres, that are stochastic to fully deterministically distributed, and of materials that have both specular and diffuse components of reflection at visible wavelengths. The present invention also provides for the detection and prediction of insurgence and propagation of undesired surface conditions (previously known or unknown defects), either spread or localised over the measured surface area, and provides for the classification of a surface across a known set of surface types. Furthermore, the present invention provides for the measurement of such surfaces and detection of conditions in real-time during the manufacturing process used to produce the part. The present invention additionally allows the generation of an automated classifier powered by machine learning principles, whose performance may be improved both from previous measurements and from simulation, and that can be adapted by training to operate on any type of surface and any number of surface conditions.

The reference light is preferably monochromatic. The reference light may be of any wavelength suitable for scattering from the surface under test. In one embodiment, the reference light is in the visible wavelength range.

The reference light is preferably substantially coherent. In this context, coherent light is light of known and consistent spatial and temporal coherence

The spot size of the reference light may be of the order of, say, 1 mm² or the like. The reference light may be incident upon the surface at any suitable angle. In some embodiment, the angle of incidence may be selected in response to expected surface properties. In some embodiments, the angle of incidence of the reference light may be varied.

The reference light may be generated by any suitable light source. In particular, the reference light may be generated by a laser or light emitting diode (LED). The light source may be provided with a suitable light focusing arrangement. The light focusing arrangement may comprise one or more lenses and/or one or more mirrors.

The reference light source may be mounted on a platform movable with respect to the surface. The platform may be operable to allow the orientation of the reference light source to be varied relative to the surface under test. The platform may be operable to allow the position of the reference light source to be translated relative to the surface under test. This allows the orientation and/or position of the light detector to be varied for optimal results. This can also allow the reference light source to be scanned across the surface. This allows measurement of topography over a wide area of the surface rather than a smaller sample area only.

The scattered reference light may be detected by any suitable detector. In one embodiment, the light detector comprises a camera. The camera is preferably adapted to be responsive to the wavelength of the reference light.

The light detector may be positioned at any suitable separation from the surface. The separation of the light detector from the surface may be selected such that a suitable range of angles of scattered reference light can be collected for the ASD. In some embodiments, the suitable range of angles may be up to 180°. The light detector may be provided with a lens arrangement operable to focus collected scattered light. The lens arrangement may have a numerical aperture sufficient to allow scattered reference light from a suitable range of angles to be collected for the ASD.

The light detector may be mounted on a platform movable with respect to the surface. The platform may be operable to allow the orientation of the light detector to be varied relative to the surface. This can enable the capture of an ASD covering a wider range of angles. The platform may be operable to allow the position of the light detector to be translated relative to the surface under test. This allows the orientation and/or position of the light detector to be varied for optimal results. This can also allow the light detector to be scanned relative to the surface under test. This allows for measurement of the surface topography over a wide area of the surface rather than a smaller sample area only.

Comparing the generated ASD to the library of sample ASDs (measured or simulated) may be carried out by any suitable processing module with classifier capability. In this context, suitable processing modules include but are not limited to neural network classifiers.

The method may include the step of mathematically encoding each ASD. In this context, this may include mathematically encoding the sample ASDs and the generated ASD. The mathematical encoding may take any suitable form. In one example, histogram binning may be used to mathematically encode each ASD.

Assigning a classification to a generated ASD may be achieved by use of a difference function. The difference function may be operable to provide a quantitative measure of difference between the generated ASD and a sample ASD. The difference function may be operable on the mathematical encoding of each ASD. The classification assigned to the generated ASD may be that of the sample ASD with the lowest measure of difference from the generated ASD. The difference function may be hardcoded for any specific application. Alternatively, the difference function may be obtained as the result of supervised machine learning trained by exposure to ASDs with known association to a surface topography condition. In one example, the supervised machine learning method is based on neural networks with shallow learning architectures (multilayer perceptron, radial basis models); in another example it is based on genetic algorithms, in another example it is based on deep learning models (convolutional neural networks).

In some embodiments, the assignment of classification may be achieved by use of multiple difference functions rather than a single difference function. In such embodiments, each difference function may be applied in each case. Alternatively, one or more difference functions may be selected for application based on particular criteria.

A sample ASD may comprise an individual ASD. In other embodiments, a sample ASD may comprise two or more individual ASDs. In the latter case, the method may include the step of grouping individual ASDs into one or more sample ASDs. The individual ASD may be grouped into a sample ASD when they fall within the same classification of surface topology.

Individual ASDs may be generated by detection using the light detector and/or by simulation. In some embodiments, the apparatus may comprise a simulation module operable to generate individual ASDs by simulation. The generated ASDs may be used to populate ASD samples stored in the ASD library and/or used for training purposes. The simulation module may be integrated with the apparatus. In many embodiments, the use of ASDs generated by simulation is preferred. This is due to the reduction in both cost and time required for classification training.

In embodiments where individual ASDs are generated by simulation, any suitable model may be used, including but not limited to: finite-difference time-domain (FDTM), finite element methods (FEM), rigorous coupled wave analysis (RCWA) or the waveguide method (WG). Whilst such models can be effective, they are of limited utility when analysis of scattering over a relatively large area (say 1 mm²) is required. In other embodiments, a scalar surface scattering model may be used. Such models are particularly appropriate where the surface topography varies at the scale of the wavelength of the reference light and the maximum surface gradient is such that multiple scattering can be neglected. In further embodiments, an extended scalar surface scattering model may be used. Such extended models may additionally expand the scattered field in terms of a bi-layer of discrete dipoles, introduce partial coherence or boundary element effects. Such extended models may be applicable with more general optically rough surfaces where multiple scattering is inherent and a rigorous vector solution of Maxwell's equations is required that properly accounts for polarisation, surface plasmons, and other effects.

In the event that it is not possible to assign a classification to the generated ASD corresponding to any of the sample ASDs in the library, the surface may be classified as having a new surface topography condition. In such instances, the measurement generated ASD may be added to the ASD library as a new sample ASD representative of the new surface topography condition. The new sample ASD may be further populated like any other sample, if new ASD are recognised as belonging to the same category.

The library of sample ASDs may be stored in a storage module. The storage module may be integrated with the apparatus. Alternatively, the storage module may be provided remotely and the processing module may access the storage module via a suitable communication link. The communication link may be a wired or wireless communication link as required or as desired.

The surface may be a surface of a manufactured article. The method may be applied after the manufacturing process. Additionally or alternatively, the method may be applied during the manufacturing process. In such cases, the manufacturing process may be controlled in response to the classification of the surface topography. This may be achieved by incorporating a topography sensing apparatus according to the present invention into a suitable manufacturing apparatus. Such a manufacturing apparatus may be provided with a control unit operable to control the manufacturing apparatus in response to the classification of the surface topography.

The article may be manufactured by an additive manufacturing process. For example, the additive manufacturing process may be binder jetting, directed energy deposition, material extrusion, material jetting, powder bed fusion, sheet lamination, and vat photopolymerization or the like. In one example, the additive manufacturing process is metal laser powder bed fusion. The additive manufacturing process may be implemented using any suitable additive manufacturing apparatus.

According to a third aspect of the present invention there is provided a manufacturing process wherein the manufacturing process includes the step of classifying the surface topography of an article manufactured by the process using the method of the first aspect of the present invention or by use of an apparatus according to the second aspect of the invention.

According to a fourth aspect of the present invention there is provided a manufacturing apparatus comprising an apparatus for measuring surface topography according to the second aspect of the invention.

The method of the third aspect of the present invention and apparatus of the fourth aspect of the invention may comprise any or all of the features of the first two aspects of the present invention as required or as desired.

### DETAILED DESCRIPTION OF THE INVENTION

In order that the invention may be more readily understood one or more embodiments thereof will now be described, by way of example only, with reference to the accompanying drawings, in which:

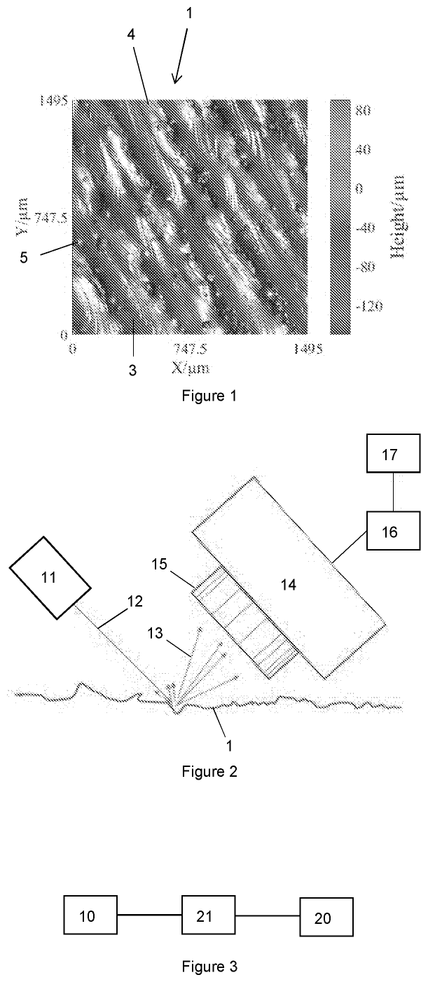

FIG. 1 illustrates the topography of an example surface formed during additive manufacture;

FIG. 2 is a schematic illustration of an apparatus for sensing the topography of a surface according op the present invention; and

FIG. 2 is a schematic block diagram illustrating the connection of the apparatus of FIG. 1 to a manufacturing process control unit.

Turning now to FIG. 1, an example of a surface 1 of an article 2 manufactured using an additive manufacturing process is shown. As can be seen, the surface 1 has a rough topography including features such as weld tracks 3, ripples 4, splattered particles 5 and the like. The image shown in FIG. 1 was developed using coherence scanning interferometry. Whilst this technique can enable accurate sensing of surface topography, it is too slow and unwieldy for use in real-time applications.

In order to control the surface topography of an article 2 manufactured using additive manufacturing, it is necessary to be able to sense surface topography in real-time. In the present invention, this is achieved by use of a surface topography sensing apparatus 10 as illustrated schematically in FIG. 2.

The apparatus 10 comprises a light source 11 operable to generate a reference light beam 12 which is incident upon the surface 1. The light source 11 is typically a laser or an LED operable to generate a substantially spatially and temporarily coherent light beam 12. Typically, the reference light beam 12 is of a visible wavelength.

Optionally, the light source 11 is mounted on a moveable platform such that the position in which the light beam 12 is incident upon surface 1 can be varied. This allows the beam 12 to be scanned across the surface 1 to build up a measure of surface topography over a wider area of the surface 1.

The reference light beam 12 is scattered from the surface 1. The scattered reference light 13 is captured by a light detector 14. In this instance, the reference light detector 14 is a camera sensitive to the wavelength of the reference light.

The light detector 14 is positioned sufficiently close to the surface 1 and has a lensing arrangement 15 with a sufficiently large numerical aperture to enable the capture of sufficient scattered light 13 for the generation of a characteristic angular scattering distribution (ASD) for the point where the beam 12 scatters from surface 1. Optionally, the light detector 14 is mounted on a moveable platform such that its position relative to surface 1 can be varied. This allows the positioning to be adjusted for optimal performance, to capture an ASD over a sufficiently wide range of scattering angles and/or to allow for the light beam 12 to be scanned across the surface 1.

The ASD is generated by a processing module 16 connected to the light detector 14. Optionally, the ASD can be generated by a processing module built into the light detector 14.

Once the ASD is generated, the processing module 16 is operable to compare the generated ASD against a library 17 of sample ASDs, each sample ASD representative of a particular expected surface topography condition for the specific application being studied. The sample ASDs may be made up of an individual ASD or of a group of ASDs matching the surface topology condition. Based on the comparison, the processing module may then assign a classification of the topography of surface 1.

Typically, the ASD library is provided in a storage module local to the processing module 16. The skilled man will nevertheless appreciate that the storage module could be remotely located and in communication with processing module 16 via a suitable communications link. In the example of FIG. 2, the processing module 16 comprises a neural network classifier.

In an embodiment, the ASD library 17 comprises ASDs generated by modelling the interaction of a sample light beam with different surface topographies or different surface topography features. This can allow the generation of a large set of sample ASDs more efficiently than using physical samples. The ASDs may be generated by a local simulation module (not shown) or by a remote simulation module in communication with the ASD library 17.

Comparison of the ASD against the ASD database 17 allows the processing module to match key features in the ASD with key features in sample ASDs stored in the ASD library. Typically, this may be achieved by storing the sample ASDs using a suitable mathematical encoding and mathematically encoding the generated ASD using the same encoding. In one example the mathematical encoding may be histogram binning. A difference function may then be used to determine whether or not the generated ASD matches any of the sample ASDs in the ASD library 17. If a matching sample ASD is found in the ASD library 17, it can then be inferred that the topography of the surface 1 under test has similar topography to the matched sample ASD. Once the neural network classifier is trained on a large library of sample ASDs generated by modelling, this step can be carried out quickly and efficiently. The present invention therefore provides for rapid qualitative analysis of the surface topography of a sample surface 1.

In the event that it is not possible to match the generated ASD to a sample ASD, then surface 1 may be classified as having a new surface topography condition. As a result, the generated ASD may be added to the ASD library 17 and used for classification of future surfaces under test.

In view of the above speed of analysis and since the light source 11 and light detector 14 can be relatively simple or low cost compared to those used in other forms of surface topography sensing, the present apparatus can be applied to control of manufacturing processes in real time. In this context, the surface topography sensing apparatus 10 can be connected to a control unit 21 for a manufacturing apparatus 20. Typically, the manufacturing apparatus 20 might be an additive manufacturing apparatus such as a metal laser powder bed fusion apparatus. Nevertheless, the skilled man will appreciate that the surface topography sensing apparatus 10 could be connected to another type of manufacturing apparatus, if appropriate.

In use, the surface topography sensing apparatus 10 is operable to sense the surface topography of the surface 1 of article 2 as it is manufactured. As a result, a qualitative classification of the surface topography is generated and output in real time. The control unit 21 is operable to receive from the apparatus 10 signals indicative of the classification of the surface topography. In the event that the received signals indicate the classification of the surface topography is within desired limits, the control unit 21 can allow operation of the manufacturing apparatus 20 to continue as planned. In the event that the received signals indicate the classification of the surface topography is outside desired limits, the control unit 21 can vary the operation of the manufacturing apparatus 20 so as to return the classification to the desired limits and or halt the operation of the manufacturing apparatus 20, as desired or appropriate.

The above embodiments are described by way of example only. Many modifications and variations are possible.

1. A method of sensing the topography of a surface, the method comprising the steps of: illuminating the surface with a reference light source; detecting reference light scattered from the surface; detecting the intensity of reference light scattered from the surface to generate an angular scattering distribution (ASD); comparing the generated ASD to a library of sample ASDs, each sample ASD being representative of a particular surface topography condition; and assigning a classification of the topography of the surface in response to the outcome of the comparison.

2. A method as claimed in claim 1 wherein the spot size of the reference light is of the order of 1 mm²

3. A method as claimed in claim 1 wherein the reference light source is scanned across the surface.

4. A method as claimed in claim 1 wherein the light detector is moveable relative to the surface.

5. A method as claimed in claim 1 wherein the method includes the step of mathematically encoding the generated ASD and each sample ASD.

6. A method as claimed in claim 4 wherein assigning a classification to a generated ASD may be achieved by use of a difference function.

7. A method as claimed in claim 6 wherein the classification assigned to the generated ASD is that of the sample ASD with the lowest measure of difference from the generated ASD.

8. A method as claimed in claim 1 wherein the difference function may be obtained as the result of supervised machine learning trained by exposure to ASDs with known association to a surface topography condition.

9. A method as claimed in claim 1 wherein a sample ASD may comprise two or more individual ASDs.

10. A method as claimed in claim 9 wherein the method include the step of grouping individual ASDs into one or more sample ASDs when the individual ASDs fall within the same classification of surface topology

11. A method as claimed in claim 1 wherein the method involves the generation of individual ASDs by simulation.

12. A method as claimed in claim 1 wherein if it is not possible to assign a classification to the generated ASD corresponding to any of the sample ASDs in the library, the surface is classified as having a new surface topography condition.

13. A method as claimed in claim 12 wherein the measurement generated ASD is added to the ASD library as a new sample ASD representative of the new surface topography condition.

14. A manufacturing process wherein the manufacturing process includes the step of classifying the surface topography of an article manufactured by the process using the method of claim 1.

15. A manufacturing process as claimed in claim 14 including the step of controlling the manufacturing process in response to the classification of the surface topography.

16. A manufacturing process as claimed in claim 14 wherein the manufacturing process is an additive manufacturing process.

17. An apparatus for sensing the topography of a surface, the apparatus comprising: a reference light source operable to illuminate the surface; a light detector operable to detect the reference light scattered from the surface; a processing module operable in response to the light detector to: generate an angular scattering distribution (ASD) of the scattered reference light; compare the generated ASD with a library of sample ASDs, each sample ASD representative of a particular surface topography condition; and assign a classification of the surface in response to the outcome of the comparison.

18. An apparatus as claimed in claim 17 wherein the reference light source is a laser or light emitting diode (LED).

19. An apparatus as claimed in claim 17 wherein the spot size of the reference light is of the order of 1 mm²

20. An apparatus as claimed in claim 17 wherein the reference light source is mounted on a platform movable with respect to the surface.

21. An apparatus as claimed in claim 17 wherein the light detector is mounted on a platform movable with respect to the surface.

22. An apparatus as claimed in claim 17 wherein the processing module comprises a neural network classifier.

23. An apparatus as claimed in claim 17 wherein the apparatus comprises a simulation module operable to generate sample ASDs by simulation.

24. An apparatus as claimed in claim 17 wherein if the processing module is not able to assign a classification to the generated ASD corresponding to any of the sample ASDs in the library, the surface is classified as having a new surface topography condition and the measurement generated ASD is added to the ASD library as a new sample ASD representative of the new surface topography condition

25. A manufacturing apparatus comprising an apparatus for measuring surface topography according to claim 17.

26. A manufacturing apparatus as claimed in claim 25 wherein the manufacturing apparatus is provided with a control unit operable to control the manufacturing apparatus in response to the classification of the surface topography.

27. A manufacturing apparatus as claimed in claim 26 wherein the manufacturing apparatus is an additive manufacturing apparatus.
